(19) United States
(12) Patent Application Publication
(10) Pub. No.: US 2006/0145431 A1
(43) Pub. Date: Jul. 6, 2006

(54) Tool connecting device

(76) Inventor: Sheng Ming Chang, Taichung Hsien (TW)

Correspondence Address: CHARLES E. BAXLEY, ESQ., 90 JOHN STREET, THIRD FLOOR, NEW YORK, NY, 10038, US

(21) Appl. No.: 11/365,454

(22) Filed: Feb. 28, 2006

Related U.S. Application Data
(63) Continuation-in-part of application No. 10/724,933, filed on Dec. 1, 2003.

(51) Int. Cl. B23B 31/16

(52) U.S. Cl. 279/74

(57) ABSTRACT

A tool connecting device includes a mandrel having a non-circular engaging hole and an orifice communicating with each other, a tool member slidably received in the engaging hole of the mandrel, and a sleeve disposed on the mandrel and having an aperture aligned with the orifice of the mandrel for receiving a retaining member. A control ferrule is slidably engaged onto the mandrel and has an actuator for actuating the retaining member to engage with and to retain the tool member to the mandrel, and the control ferrule includes a peripheral recess for receiving the retaining member and for allowing the retaining member to be disengaged from the tool member.

The present invention is a continuation-in-part of U.S. patent application Ser. No. 10/724,933, filed 1 Dec. 2003, pending and to be abandoned.

### BACKGROUND OF THE INVENTION

1. Field of the Invention

The present invention relates to a tool connecting device, and more particularly to a tool connecting device for connecting a tool member to a mandrel to allow the tool member to be selectively secured to the mandrel and rotated in concert with the mandrel or to be rotated or driven by the mandrel.

2. Description of the Prior Art

Typical tool connecting devices comprise a tool member or tool bit to be attached or coupled to a mandrel with a magnetic attracting or holding device and arranged to allow the tool bit to be selectively secured to the mandrel and rotated in concert with the mandrel or to be rotated or driven by the mandrel.

For example, U.S. Pat. No. 5,577,426 to Eggert et al. discloses one of the typical magnetic bit holder and hand tool assemblies also comprising a tool bit to be attached or coupled to a mandrel with a magnet and arranged to allow the tool bit to be selectively secured to the mandrel and rotated in concert with the mandrel or to be rotated or driven by the mandrel. However, the tool bit may not be solidly secured to the mandrel and may have a good chance to be disengaged from the mandrel.

U.S. Pat. No. 6,637,755 to Chen et al. discloses another typical chuck device for miniature tool bits comprising a tool member or tool bit to be attached or coupled to a mandrel, and a position ball to be forced to engage with the tool member or tool bit by a movable sleeve, in which the movable sleeve includes an annular rib for engaging with the position ball. However, the annular rib of the movable sleeve may not be easily moved and engaged with the position ball and may not swiftly actuate the position ball.

The present invention has arisen to mitigate and/or obviate the afore-described disadvantages of the conventional tool connecting devices.

### SUMMARY OF THE INVENTION

The primary objective of the present invention is to provide a tool connecting device for connecting a tool member to a mandrel to allow the tool member to be selectively secured to the mandrel and rotated in concert with the mandrel or to be rotated or driven by the mandrel.

In accordance with one aspect of the invention, there is provided a tool connecting device comprising a mandrel including a non-circular engaging hole formed therein, and including an orifice formed therein and communicating with the engaging hole of the mandrel, a tool member slidably received in the non-circular engaging hole of the mandrel, for being attaching to the mandrel and for being rotated and driven by the mandrel, a sleeve disposed on the mandrel and having an aperture aligned with the orifice of the mandrel, a retaining member received in the orifice of the mandrel and received in the aperture of the sleeve, and movable into the engaging hole of the mandrel, a control ferrule slidably engaged onto the mandrel and having an actuator for selectively engaging with the retaining member to actuate the retaining member to engage with the tool member and to selectively retain the tool member in engagement with the non-circular engaging hole of the mandrel, and the control ferrule including a peripheral recess formed therein for selectively receiving the retaining member and for allowing the retaining member to be disengaged from the tool member, and a spring biasing device for biasing the actuator to engage with the retaining member.

A retaining ring is further provided and attached onto the mandrel for engaging with the sleeve and for anchoring the sleeve to the mandrel. The control ferrule includes a flange for engaging with the retaining ring and for limiting the control ferrule to slide relative to the mandrel and for preventing the control ferrule from being disengaged from the mandrel.

The control ferrule includes a stop engaged therein, and the biasing device includes a spring member engaged between the sleeve and the stop of the control ferrule. The tool member includes at least one notch formed therein for selectively engaging with the retaining member and to selectively anchor and retain the tool member in engagement with the non-circular engaging hole of the mandrel.

The mandrel includes a spring member disposed therein and engaged with the tool member for biasing the tool member out of the engaging hole of the mandrel. The mandrel includes a cavity communicating with the engaging hole for receiving the spring member.

The mandrel includes a magnetic attracting device for attracting and retaining the tool member to the mandrel. The mandrel includes a spring member engaged with the tool member, and the magnetic attracting device may be attached to the spring member. Alternatively, the magnetic attracting device may be attached or secured to the mandrel instead of attaching to the spring member.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is a perspective view of a tool connecting device in accordance with the present invention;

FIG. 2 is an exploded view of the tool connecting device;

FIG. 3 is a partial plan schematic view of the tool connecting device in which a portion of the tool connecting device has been cut off for showing an inner structure of tool connecting device;

FIGS. 4, 5, 6 are partial plan schematic views similar to FIG. 3, illustrating the operation of the tool connecting device;

FIG. 7 is a partial plan schematic view similar to FIGS. 3-6, illustrating the other arrangement or application of the tool connecting device;

FIG. 8 is an exploded view of the tool connecting device as shown in FIG. 7; and

FIG. 9 is a cross sectional view illustrating the further arrangement or application of the tool connecting device.

### DETAILED DESCRIPTION OF THE PREFERRED EMBODIMENT

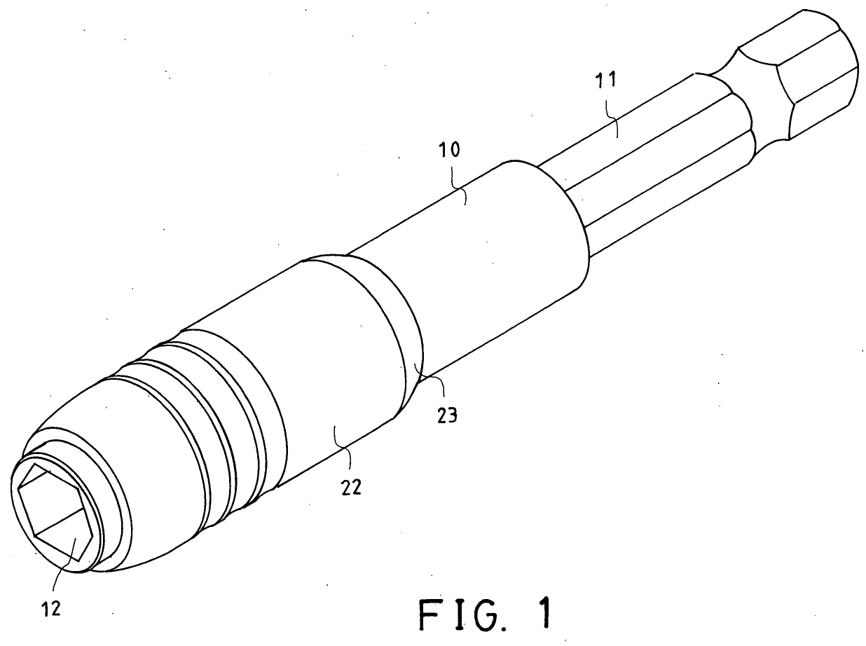

Referring to the drawings, and initially to FIGS. 1-3, a tool connecting device in accordance with the present invention comprises a mandrel 10 including a stem 11 provided or extended on one end thereof for coupling to various driving tools, such as wrenches, power tools, tool extensions, etc., and including an engaging hole 12 formed in the other end thereof for slidably and/or rotatably or pivotally receiving a tool member 30 therein, and including an orifice 13 formed in the other end thereof and communicating with the engaging hole 12 thereof for receiving a ball or retaining member 14 therein. It is preferable that the engaging hole 12 of the mandrel 10 includes a non-circular cross section, such as a hexagonal cross section.

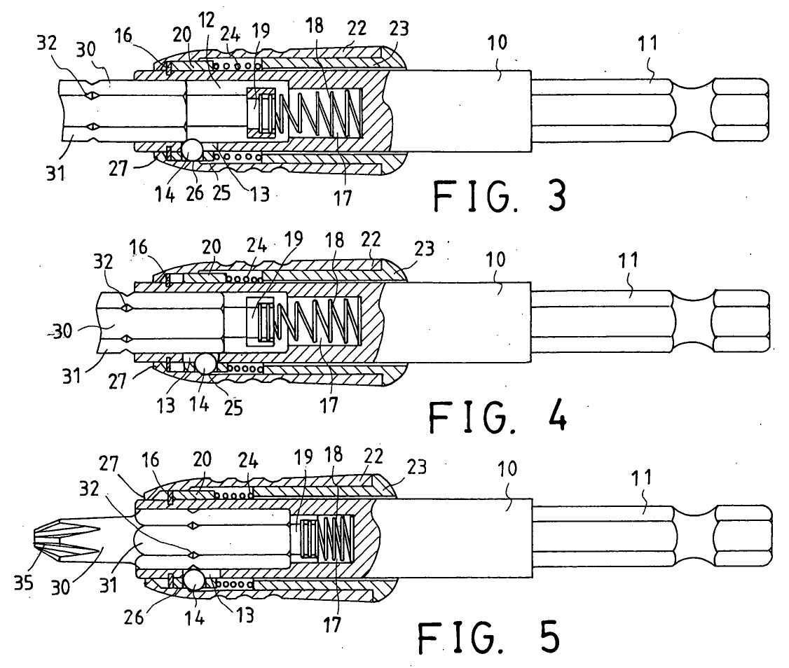

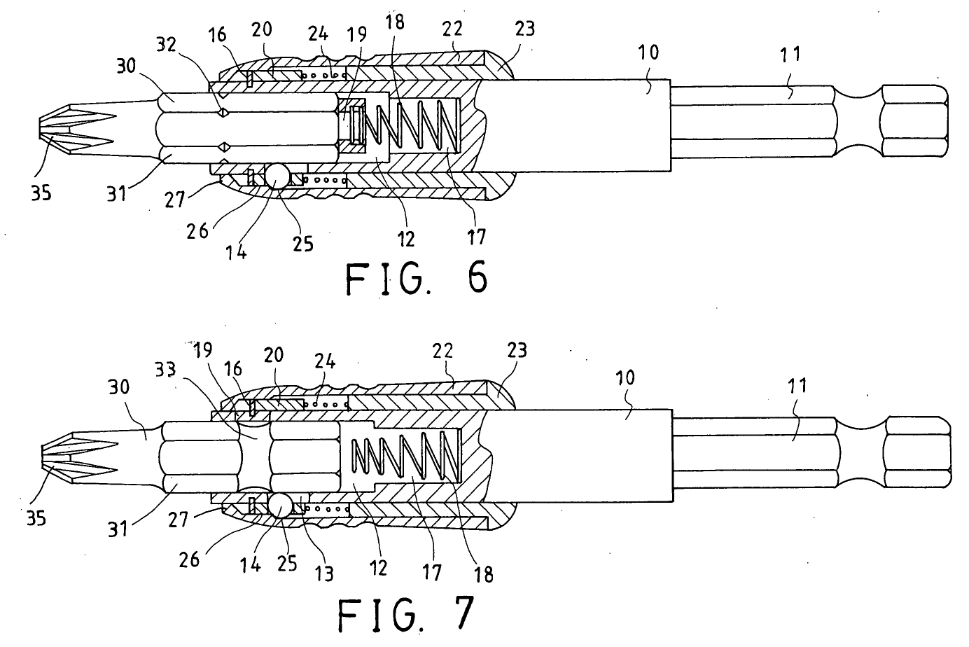

The mandrel 10 includes an annular groove 15 formed in the outer peripheral portion of the other end thereof for receiving or engaging with a clamping or retaining ring 16 therein, and includes a cavity 17 formed in the inner portion thereof and communicating with the engaging hole 12 thereof for receiving a spring member 18 therein (FIGS. 3-7 and 9) which is extendible or engageable into the engaging hole 12 of the mandrel 10. The mandrel 10 further includes a magnetic attracting or holding device 19 optionally or selectively attached to the spring member 18 and also extendible or engageable into the engaging hole 12 of the mandrel 10 (FIGS. 3-6 and 9) for attracting and retaining the tool member 30 to the mandrel 10.

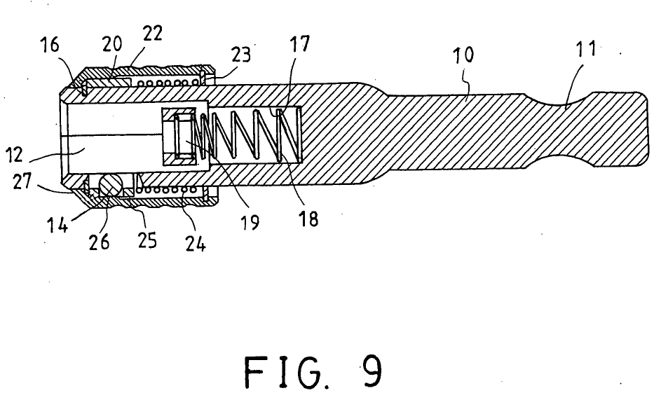

A ring member or sleeve 20 is engaged onto the mandrel 10 and contacted or engaged with the clamping or retaining ring 16 of the mandrel 10 for being anchored and positioned on the mandrel 10, and includes an aperture 21 formed therein for aligning with the orifice 13 of the mandrel 10 and for receiving the retaining member 14 therein. The sleeve 20 may also be formed integral with the mandrel 10 and formed as a portion of the mandrel 10. A control ferrule 22 is slidably engaged onto the mandrel 10 and the sleeve 20, and includes a casing or stop 23, such as a peripheral stop 23 attached or engaged or secured in one end, such as the rear end portion thereof. Alternatively, the peripheral stop 23 may be directly extended from or formed integral with the rear end portion of the sleeve 20 (FIG. 9).

Another spring member 24 is also engaged onto the mandrel 10 and contacted or engaged with or engaged between the sleeve 20 and the stop 23 of the control ferrule 22 for biasing the stop 23 of the control ferrule 22 away from the sleeve 20, for example. The control ferrule 22 includes a peripheral recess 25 formed in the inner peripheral portion thereof for selectively receiving the retaining member 14 therein, and includes an actuator 26, such as a peripheral actuator 26 provided in the inner peripheral portion thereof or extended into the peripheral recess 25 thereof for selectively engaging with and actuating or forcing the retaining member 14 to engage into the engaging hole 12 of the mandrel 10 (FIG. 3).

The spring member 24 may also be used to bias the actuator 26 to selectively engage with or to actuate the retaining member 14. The control ferrule 22 further includes a flange 27, such as a peripheral flange 27 extended in the inner peripheral portion thereof and provided in the other end or the front end of the control ferrule 22 for selectively engaging with the retaining ring 16 (FIGS. 3, 4) and for limiting the control ferrule 22 to slide or move relative to the mandrel 10 and the sleeve 20, and for preventing the control ferrule 22 from being disengaged from the mandrel 10 and the sleeve 20.

In operation, the control ferrule 22 may be moved relative to the mandrel 10 and moved toward the retaining ring 16 and the tool member 30 against the spring member 24, to allow the retaining member 14 to be selectively engaged and received in the peripheral recess 25 of the control ferrule 22 (FIG. 4) and thus to allow the retaining member 14 to be disengaged from the engaging hole 12 of the mandrel 10. When the control ferrule 22 is released, the spring member 24 may bias the control ferrule 22 away from the retaining ring 16 and toward the stem 11 and to selectively force the actuator 26 to engage with the retaining member 14 and to actuate the retaining member 14 to engage into the engaging hole 12 of the mandrel 10 again (FIG. 3).

The tool member 30 includes an intermediate or anchoring segment 31 having a non-circular cross section formed or provided therein for selectively engaging with the corresponding non-circular engaging hole 12 of the mandrel 10, to allow the tool member 30 to be selectively anchored or secured to the mandrel 10 and to be selectively rotated in concert with the mandrel 10. The tool member 30 includes one or more notches 32 formed therein, such as formed in the anchoring segment 31 thereof for selectively engaging with the retaining member 14 (FIG. 5) which may anchor and secure the anchoring segment 31 of the tool member 30 in engagement with the retaining member 14.

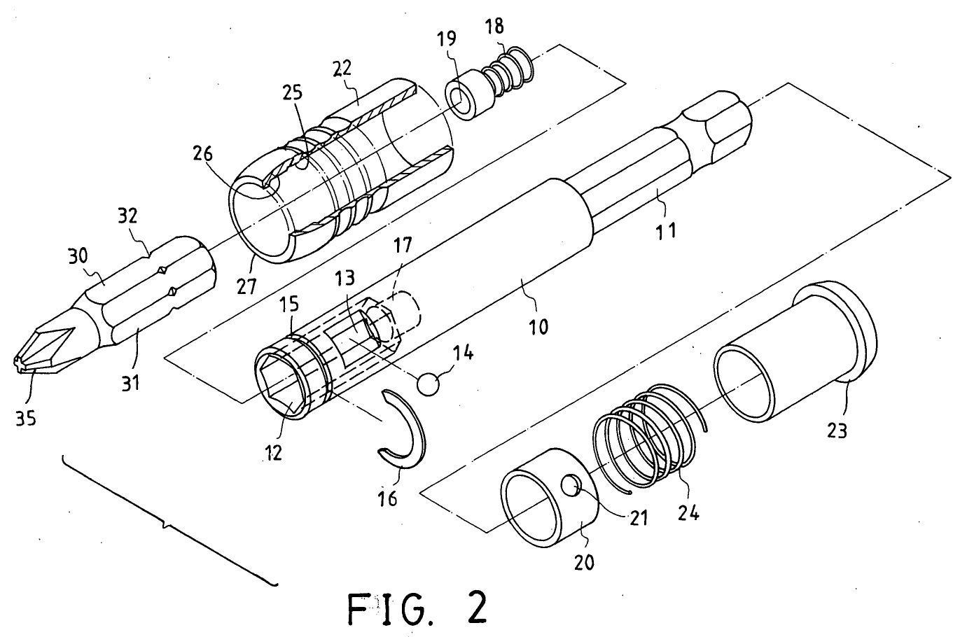

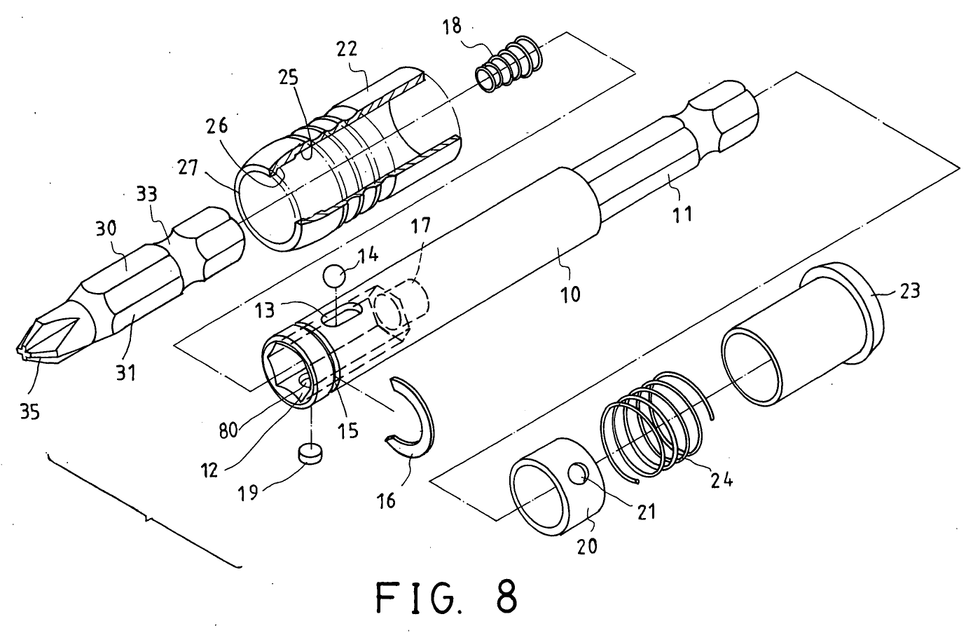

Alternatively, as shown in FIGS. 7 and 8, the tool member 30 may include a peripheral depression 33 formed therein, such as formed in the middle portion thereof for selectively engaging with the retaining member 14 which may anchor and secure the tool member 30 in engagement with the mandrel 10. The tool member 30 includes a tool element or tool bit 35 formed or provided on the other end thereof (FIGS. 2, 5-6) for engaging with various fasteners, tool members, tool extensions or the like. Instead of attaching to the spring member 18, the magnetic attracting or holding device 19 may be optionally or selectively attached and engaged in an aperture 80 of the mandrel 10 (FIG. 8) for attracting and retaining the tool member 30 to the mandrel 10.

The actuator 26 of the control ferrule 22 may be used or acted as an actuating means or device for actuating the retaining member 14 to engage with either the notches 32 (FIGS. 2, 5) or the peripheral depression 33 (FIGS. 7, 8) of the tool member 30 and to selectively anchor and secure the anchoring segment 31 of the tool member 30 to the mandrel 10, and thus to allow the tool member 30 either to be selectively rotated in concert with the mandrel 10 and to be rotated and driven by the mandrel. The anchoring segment 31 of the tool member 30 may also include a non-circular cross section, such as a square or rectangular cross section, or the like for engaging with the corresponding non-circular engaging hole 12 of the mandrel 10.

In operation, as shown in FIG. 4, when the control ferrule 22 is moved relative to the mandrel 10 and against the spring member 24 to allow the retaining member 14 to be selectively engaged and received in the peripheral recess 25 of the control ferrule 22 (FIG. 4), the retaining member 14 may be disengaged from the engaging hole 12 of the mandrel 10 for allowing the tool member 30 to be engaged into or disengaged from the engaging hole 12 of the mandrel 10. When the non-circular anchoring segment 31 of the tool member 30 is selectively engaged with the corresponding non-circular engaging hole 12 of the mandrel 10, the retaining member 14 may be forced to selectively engage with either of the notches 32 of the tool member 30 (FIG. 5) to selectively anchor or secure the tool member 30 to the mandrel 10 and to allow the tool member 30 to be rotated in concert with the mandrel 10.

That is, when the control ferrule 22 is moved relative to the mandrel 10 and moved toward the retaining ring 16 and moved away from the stem 11 against the spring member 24, the peripheral recess 25 of the control ferrule 22 may be moved to be aligned with the retaining member 14 and to selectively engage and receive the retaining member 14 therein, and thus to allow the retaining member 14 to be disengaged from the notches 32 of the tool member 30 in order to release the tool member 30 from the mandrel 10, and thus to allow the tool member 30 to be sprung or forced out of the engaging hole 12 of the mandrel 10 by such as the spring member 18, and to allow the tool member 30 to be easily fetched by the users.

When the control ferrule 22 is released, the spring member 24 may bias the control ferrule 22 away from the retaining ring 16 to selectively force the actuator 26 to engage with and to actuate the retaining member 14 to engage into the engaging hole 12 of the mandrel 10 and thus to engage with the notches 32 or the peripheral depression 33 of the tool member 30 and to solidly attach or secure or retain the tool member 30 to the mandrel 10, and for preventing the tool member 30 from being removed or disengaged from the mandrel 10.

Accordingly, the tool connecting device in accordance with the present invention may be provided for connecting a tool member to a mandrel to allow the tool member to be selectively secured to the mandrel and rotated in concert with the mandrel or to be rotated or driven by the mandrel.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A tool connecting device comprising:
a mandrel including a non-circular engaging hole formed therein, and including an orifice formed therein and communicating with said engaging hole of said mandrel,
a tool member slidably received in said non-circular engaging hole of said mandrel, for being attaching to said mandrel and for being rotated and driven by said mandrel,
a sleeve disposed on said mandrel and having an aperture aligned with said orifice of said mandrel,
a retaining member received in said orifice of said mandrel and received in said aperture of said sleeve, and movable into said engaging hole of said mandrel,
a control ferrule slidably engaged onto said mandrel and having an actuator for selectively engaging with said retaining member to actuate said retaining member to engage with said tool member and to selectively retain said tool member in engagement with said non-circular engaging hole of said mandrel, and said control ferrule including a peripheral recess formed therein for selectively receiving said retaining member and for allowing said retaining member to be disengaged from said tool member, and
means for biasing said actuator to engage with said retaining member.

2. The tool connecting device as claimed in claim 1, wherein a retaining ring is attached onto said mandrel for engaging with said sleeve and for anchoring said sleeve to said mandrel.

3. The tool connecting device as claimed in claim 2, wherein said control ferrule includes a flange for engaging with said retaining ring and for limiting said control ferrule to slide relative to said mandrel and for preventing said control ferrule from being disengaged from said mandrel.

4. The tool connecting device as claimed in claim 1, wherein said control ferrule includes a stop engaged therein, and said biasing means includes a spring member engaged between said sleeve and said stop of said control ferrule.

5. The tool connecting device as claimed in claim 1, wherein said tool member includes at least one notch formed therein for selectively engaging with said retaining member and to selectively retain said tool member in engagement with said non-circular engaging hole of said mandrel.

6. The tool connecting device as claimed in claim 1, wherein said mandrel includes a spring member disposed therein and engaged with said tool member for biasing said tool member out of said engaging hole of said mandrel.

7. The tool connecting device as claimed in claim 6, wherein said mandrel includes a cavity communicating with said engaging hole for receiving said spring member.

8. The tool connecting device as claimed in claim 7, wherein said mandrel includes a magnetic attracting device for attracting and retaining said tool member to said mandrel.

9. The tool connecting device as claimed in claim 8, wherein said mandrel includes a spring member engaged with said tool member, said magnetic attracting device is attached to said spring member.
